(19) United States
(12) Patent Application Publication
(10) Pub. No.: US 2024/0383123 A1
(43) Pub. Date: Nov. 21, 2024

(54) TRIGGER SWITCH AND ELECTRIC DEVICE

(71) Applicant: OMRON Corporation, KYOTO (JP)

(72) Inventors: Takumi FUJIHARA, Kyoto-shi (JP); Yohei TSUKANAKA, Kyoto-shi (JP); Yusaku YAMASAKI, Kyoto-shi (JP); Takahiro UEDA, Kyoto-shi (JP); Taiki KOYAMA, Kyoto-shi (JP)

(73) Assignee: OMRON Corporation, KYOTO (JP)

(21) Appl. No.: 18/634,973

(22) Filed: Apr. 14, 2024

(30) Foreign Application Priority Data
May 19, 2023 (JP) 2023-083404
Jul. 26, 2023 (JP) 2023-121507

(51) Int. Cl. B25F 5/02; H01H 9/06

(52) U.S. Cl. CPC B25F 5/02; H01H 9/06; H01H 2009/066

(57) ABSTRACT

A trigger switch includes a trigger that receives a push-in operation of an operator, and a shaft member that supports the trigger. The trigger moves in an operation direction in which the trigger is pushed in by the push-in operation. The trigger includes a trigger cap including a finger hooking part onto which a finger of the operator is hooked, and a holding member that holds the trigger cap and is supported by the shaft member. The trigger cap is attachable and removable to and from the holding member. An electric device includes the trigger switch, and a body device that is driven in response to a push-in operation on the trigger switch. The body device includes a visual check part that allows visual checking of an attachment state of the trigger cap in the trigger switch.

### CROSS-REFERENCE TO RELATED APPLICATION

This application claims the priority benefit of Japan application serial no. 2023-083404, filed on May 19, 2023, and Japan application serial no. 2023-121507, filed on Jul. 26, 2023. The entirety of the above-mentioned patent applications is hereby incorporated by reference herein and made a part of this specification.

### BACKGROUND

### Technical Field

The disclosure relates to a trigger switch including a trigger that receives a push-in operation, and an electric device including such a trigger switch.

### Related Art

A trigger switch used in an operation of an electric tool includes a trigger that receives a push-in operation of an operator, and a shaft member that supports the trigger. With the operator hooking a finger onto the trigger and pulling (pushing in) the trigger, the shaft member moves in an operation direction to activate the trigger switch, and the electric tool operates. For example, a trigger switch described in Patent Document 1 (Specification of Japanese Patent No. 5898993) is integrated by joining a trigger and a plunger (shaft member) with a pin.

There are various requirements for triggers included in electric devices such as electric tools. For example, there may be requirements for changes in a color or a shape of the trigger or replacement with a new trigger. However, the conventional trigger switch attached to the plunger with pin joining as proposed in Patent Document 1 does not have a structure that allows easy replacement and does not satisfy requirements for replacement and the like.

### SUMMARY

A trigger switch according to an embodiment of the disclosure includes: a trigger that receives a push-in operation of an operator; and a shaft member that supports the trigger. The trigger moves in an operation direction in which the trigger is pushed in by the push-in operation. The trigger includes: a trigger cap including a finger hooking part onto which a finger of the operator is hooked; and a holding member that holds the trigger cap and is supported by the shaft member. The trigger cap is attachable and removable to and from the holding member.

Further, in the trigger switch, the holding member is formed with a regulating part that performs regulation such that a direction of attachment or removal of the trigger cap is a predetermined intersection direction intersecting with the operation direction.

Further, in the trigger switch, attachment of the trigger cap to the holding member is performed with a snap-fit structure in which a locking claw engages with a locking part.

Further, in the trigger switch, the trigger cap is attached by fitting over the holding member. The holding member is formed with the locking part. The trigger cap includes: a wall body that covers the locking part upon fitting over; and a locking piece formed with the locking claw at a tip. The locking piece is formed at a position separated from an inner surface of the wall body on an inner side of the wall body. A site of the wall body that is opposed to the locking claw is formed into a recessed shape.

Further, in the trigger switch, the trigger cap is formed with the locking part. The holding member is a locking piece formed with the locking claw at a tip.

Further, in the trigger switch, the trigger cap is formed with a through hole. The trigger switch further includes a locking pin capable of being inserted into the through hole. By inserting the locking pin into the through hole of the trigger cap attached to the holding member, the locking pin locks the trigger cap, and the trigger cap is fixed.

Further, in the trigger switch, the through hole penetrates from an outer side of the trigger cap to an inner side where the holding member is located. The holding member is formed with an insertion hole at a position facing the through hole, a tip of the locking pin being capable of being inserted into the insertion hole. The locking pin is a pin screw forming a male screw structure, and is capable of fixing the trigger cap to the holding member by penetrating from the outer side of the trigger cap through the through hole and inserting the tip into the insertion hole. The through hole or the insertion hole forms a female screw structure that screws with the locking pin.

Further, in the trigger switch, the through hole penetrates from an outer side of the trigger cap to an inner side where the holding member is located. The holding member is formed with an insertion hole at a position facing the through hole, a tip of the locking pin being capable of being inserted into the insertion hole. The locking pin is capable of fixing the trigger cap to the holding member by penetrating from the outer side of the trigger cap through the through hole and inserting the tip into the insertion hole. The trigger switch includes a detachment preventing member that prevents detachment of the locking pin inserted into the through hole.

Further, in the trigger switch, the through hole penetrates from an outer side of the trigger cap to an inner side where the holding member is located. The locking pin is movably attached to the holding member. The locking pin is capable of fixing the trigger cap to the holding member by inserting from the inner side of the trigger cap into the through hole. With the locking pin inserted into the through hole coming off from the through hole with pressing from outside of the trigger cap, fixing of the trigger cap to the holding member is released.

Furthermore, an electric device according to an embodiment of the disclosure includes: the trigger switch; and a body device that is driven in response to a push-in operation on the trigger switch. The body device includes a visual check part that allows visual checking of an attachment state of the trigger cap in the trigger switch.

Furthermore, an electric device according to an embodiment of the disclosure includes: the trigger switch; and a body device that is driven in response to a push-in operation on the trigger switch. The body device is formed with an opening in a periphery of an attachment site of the trigger cap, and includes an adjustment member that adjusts a size of the opening.

Furthermore, an electric device according to an embodiment of the disclosure includes: the trigger switch; and a body device that is driven in response to a push-in operation on the trigger switch. The body device includes a door part that opens and closes a periphery of an attachment site of the trigger cap.

The trigger switch and the like of the embodiments of the disclosure include the trigger with the trigger cap and the holding member and achieve excellent effects such as being capable of replacing the trigger cap of the trigger.

### BRIEF DESCRIPTION OF DRAWINGS

FIG. 1 is a schematic perspective view illustrating an example of the appearance of an electric device of the disclosure.

FIG. 2 is a schematic perspective view illustrating an example of the appearance of a trigger switch of the disclosure.

FIG. 3 is a schematic perspective view illustrating an example of the trigger switch of the disclosure.

FIG. 4 is a schematic side view illustrating an example of a trigger cap included in the trigger switch of the disclosure.

FIG. 5 is a schematic rear view illustrating an example of the trigger cap included in the trigger switch of the disclosure.

FIG. 6 is a schematic cross-sectional side view illustrating an example of the trigger cap included in the trigger switch of the disclosure.

FIG. 7 is a schematic perspective view illustrating an example of a holding member and a shaft member included in the trigger switch of the disclosure.

FIG. 8 is a view illustrating an example of an attachment method of the trigger cap in the trigger switch of the disclosure.

FIG. 9 is a view illustrating an example of a removal method of the trigger cap in the trigger switch of the disclosure.

FIG. 10 is a view illustrating an example of a work associated with attachment of the trigger cap in the electric device of the disclosure.

FIG. 11 is a view illustrating an example of a work associated with attachment of the trigger cap in the electric device of the disclosure.

FIG. 12 is a view illustrating an example of a work associated with attachment of the trigger cap in the electric device of the disclosure.

FIG. 13 is a conceptual view illustrating an example of replacement of the trigger cap of the trigger switch of the disclosure.

FIG. 14 is a schematic perspective view illustrating an example of a trigger of the disclosure.

FIG. 15 is a schematic exploded perspective view illustrating an example of the trigger of the disclosure.

FIG. 16 is a schematic perspective view illustrating an example of a trigger of the disclosure.

FIG. 17 is a schematic exploded perspective view illustrating an example of the trigger of the disclosure.

FIG. 18 is a schematic perspective view illustrating an example of a trigger of the disclosure.

FIG. 19 is a schematic perspective view illustrating an example of a trigger of the disclosure.

FIG. 20 is a schematic perspective view illustrating an example of a trigger of the disclosure.

FIG. 21 is a schematic perspective view illustrating an example of a trigger of the disclosure.

FIG. 22 is a view illustrating an example of a work associated with attachment of a trigger cap in an electric device of the disclosure.

FIG. 23 is a view illustrating an example of a work associated with attachment of a trigger cap in an electric device of the disclosure.

FIG. 24 is a view illustrating an example of a work associated with attachment of a trigger cap in an electric device of the disclosure.

### DESCRIPTION OF EMBODIMENTS

Embodiments of the disclosure provide a trigger switch in which a trigger is configured using a trigger cap and a holding member and the trigger cap is attachable and removable.

Further, other embodiments of the disclosure provide an electric device using the trigger switch of the disclosure.

Hereinafter, embodiments of the disclosure will be described with reference to the drawings.

### Application Example

A trigger switch of the disclosure is applicable to various electric devices, including electric tools such as an electric drill, an electric driver, an electric wrench, and an electric grinder including a drive part such as a motor. Hereinafter, with reference to the drawings, several embodiments relating to an electric device PT illustrated in the drawings will be described.

### First Embodiment

### Electric Device PT

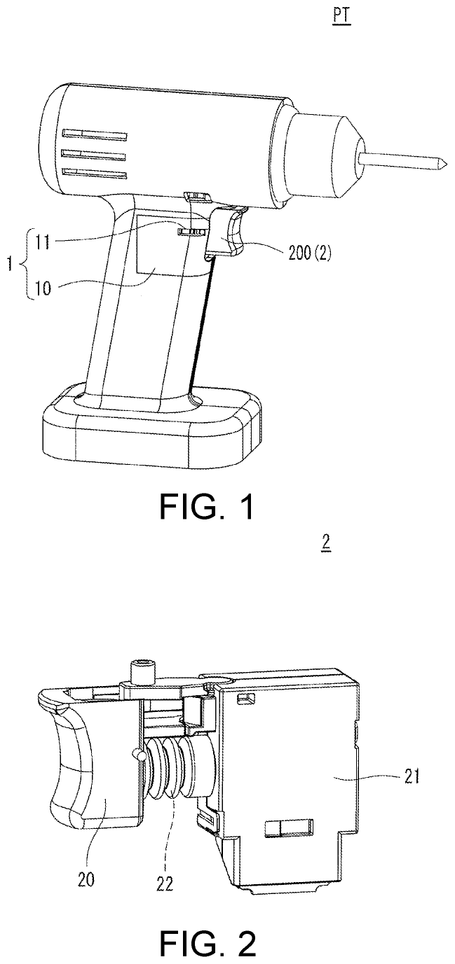

FIG. 1 is a schematic perspective view illustrating an example of the appearance of an electric device PT of the disclosure. The electric device PT of the disclosure is applicable to various devices, including electric tools such as an electric drill, an electric driver, an electric wrench, and an electric grinder, and further, a water gun, a paint gun, a model guns, etc. including a trigger switch 2. The electric device PT illustrated in FIG. 1 includes a body device 1. A trigger switch 2 receiving a push-in operation of a user is incorporated into the body device 1. The body device 1 is provided with a door part 10 capable of opening and closing. A window part 11 (visual check part) that allows visual checking of an attachment state of a trigger cap 200 included in the trigger switch 2 is provided at the door part 10. The window part 11 illustrated in FIG. 1 is formed as a long narrow groove in which an operation direction related to the push-in operation is a longitudinal direction. FIG. 1 illustrates an example in which an opening is formed as the window part 11, but a display part that displays characters or images indicating the attachment state may also be provided as the visual check part. The electric device PT illustrated in FIG. 1 has a shape in which a hand-held portion is attached to a substantially cylindrical portion. In the following description, as illustrated in the drawing, the direction of the substantially cylindrical portion will be described as “up” and the direction of the hand-held portion will be described as “down”. Further, the direction in which the trigger cap 200 of the trigger switch 2 is located will be described as “front”, and the direction in which the trigger switch 2 is pushed in will be described as “rear”. That is, in the electric device PT and the trigger switch 2, the direction from the front side toward the rear side is the operation direction in which the trigger is pushed in by the push-in operation. These are directions for convenience of illustration and do not limit the directions of use of the electric device PT and the trigger switch 2.

FIG. 1 illustrates a released state in which an operator is not operating the trigger switch 2. From the released state illustrated in FIG. 1, the operator hooks a finger onto the trigger switch 2 and performs a push-in operation of pushing in the trigger switch 2 toward the body device 1 side (rear side) to thus drive a drive part (not illustrated) such as an electric motor built in the body device 1.

### Trigger Switch 2

Next, the trigger switch 2 included in the electric device PT will be described. FIG. 2 is a schematic perspective view illustrating an example of the appearance of the trigger switch 2 of the disclosure. FIG. 2 illustrates the appearance of the trigger switch 2 of the disclosure from a diagonally upper viewpoint. The trigger switch 2 includes members such as a trigger 20, a housing 21, and a shaft member 22.

The trigger 20 is a member that receives a push-in operation of the user and is incorporated into the electric device PT in an exposed state to be operable. The housing 21 accommodates various members such as various circuits and a spring that biases against the push-in of the trigger 20 and is incorporated inside the electric device PT. The shaft member 22 is a member that connects the trigger 20 and the housing 21. The shaft member 22 is a long narrow metal plunger, and is illustrated as covered with flexible bellows in FIG. 2. The shaft member 22 supports the trigger 20 on one end side, and the other end side is inserted inside the housing 21.

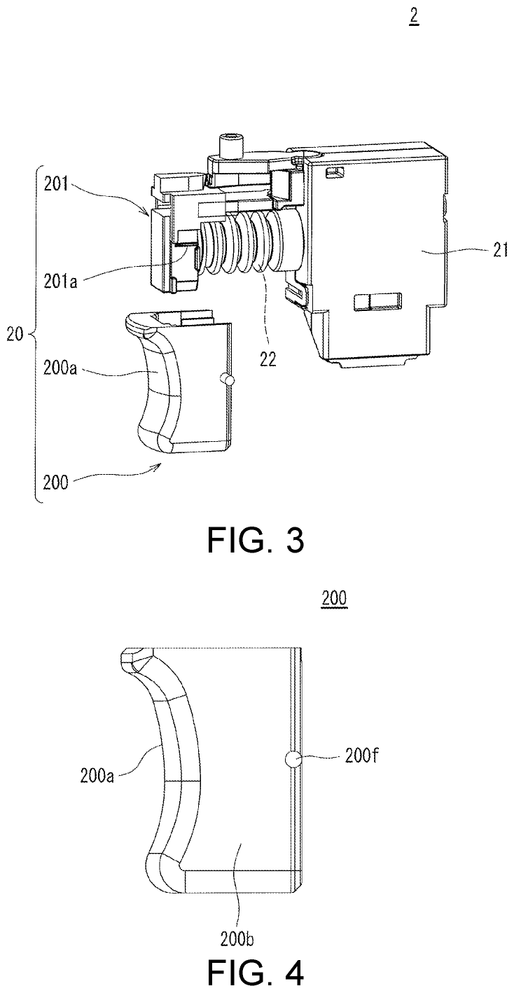

FIG. 3 is a schematic perspective view illustrating an example of the trigger switch 2 of the disclosure. The trigger 20 included in the trigger switch 2 is configured using a trigger cap 200 and a holding member 201, and the trigger cap 200 is attachable and removable to and from the holding member 201. The trigger cap 200 has a finger hooking part 200a onto which the operator's finger is hooked, and the finger hooking part 200a is curved in a recessed shape such that the finger can be easily hooked thereon. Details of the trigger cap 200 will be described later.

The holding member 201 is a member that holds the attached trigger cap 200 and is supported by the shaft member 22. The holding member 201 is formed with locking parts 201a at two spots forming a pair on left and right lateral surfaces. The locking parts 201a at two spots are respectively provided as recesses on two lateral parts of the holding member 201. The holding member 201 engages with the trigger cap 200 by the locking parts 201a.

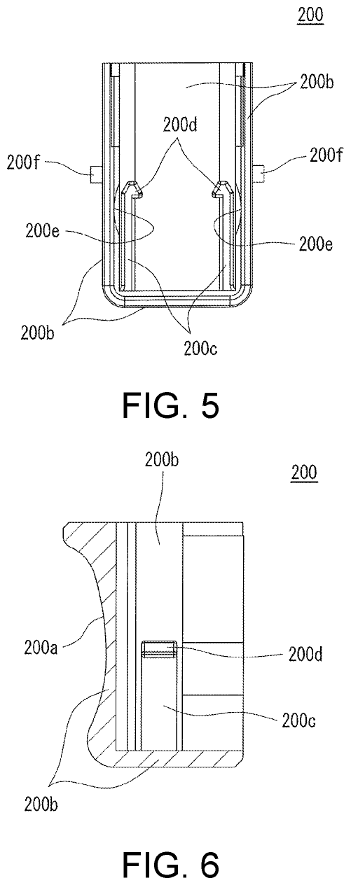

The trigger cap 200 and the holding member 201 of the trigger 20 included in the trigger switch 2 of the disclosure and their attachment and removal will be further described. FIG. 4 is a schematic side view illustrating an example of the trigger cap 200 included in the trigger switch 2 of the disclosure. FIG. 5 is a schematic rear view illustrating an example of the trigger cap 200 included in the trigger switch 2 of the disclosure. FIG. 6 is a schematic cross-sectional side view illustrating an example of the trigger cap 200 included in the trigger switch 2 of the disclosure.

The trigger cap 200 forms a substantially rectangular parallelepiped shape with a hollow inside, in which a wall body 200b is formed at positions corresponding to a front surface, a right lateral surface, a left lateral surface, and a bottom surface, with a top surface and a rear surface being opened. The trigger cap 200 is configured to be attached by fitting over the holding member 201, and is formed such that the holding member 201 enters the hollow portion inside the trigger cap 200. In the case where the trigger cap 200 is fitted over the holding member 201, the front portion of the wall body 200b covers the front surface of the holding member 201. The outer surface of the front portion of the wall body 200b of the trigger cap 200 serves as the finger hooking part 200a onto which the operator's finger is hooked. In the case where the trigger cap 200 is fitted over the holding member 201, the left and right portions of the wall body 200b cover the locking parts 201a formed on two lateral surfaces of the holding member 201. Further, in the case where the trigger cap 200 is fitted over the holding member 201, the lower portion of the wall body 200b covers the bottom surface of the holding member 201.

The trigger cap 200 includes a pair of locking pieces 200c protruding upward from an inner bottom surface in the vicinity of the left and right portions of the wall body 200b. Locking claws 200d protruding to face each other are formed at the tips of the respective locking pieces 200c. The locking claw 200d protruding from the locking piece 200c is formed such that a lower surface of the locking claw 200d forms a substantially right angle with respect to an up-down direction, which is the extending direction of the locking piece 200c, and an upper surface of the locking claw 200d is formed into a tapered shape that has a narrowed tip and intersects obliquely with the extending direction of the locking piece 200c. The locking claw 200d of the trigger cap 200 forms a snap-fit structure that engages with the locking part 201a of the holding member 201. The locking pieces 200c are formed at positions separated from the wall body 200b in the vicinity of the left and right portions of the wall body 200b. Further, in the left and right portions of the wall body 200b, sites opposed to the locking claws 200d are formed as arcuate surfaces 200e recessed into recessed shapes. When attaching and removing the trigger cap 200 to and from the holding member 201, the locking pieces 200c forming snap-fit structures spread toward the outer side, but there is a gap between the locking pieces 200c and the wall body 200b, and moreover, the arcuate surfaces 200e in recessed shapes are formed. Accordingly, the locking pieces 200c spread toward the outer side easily.

The trigger cap 200 is formed with regulating protrusions 200f on the left and right lateral surfaces to regulate movement of the trigger 20 in the push-in operation. In the case where the trigger 20 is attached to the body device 1, the regulating protrusion 200f of the trigger cap 200 is inserted into the window part 11 of the body device 1, and moves in the front-rear direction along the window part 11 together with the movement of the trigger 20 in the push-in operation.

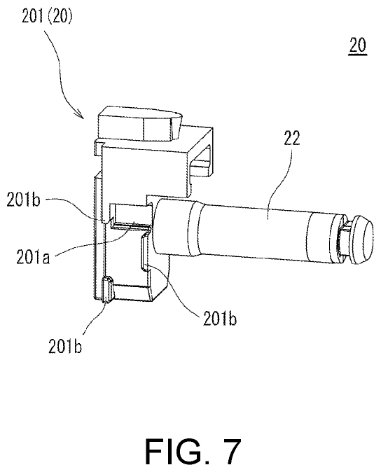

FIG. 7 is a schematic perspective view illustrating an example of the holding member 201 and the shaft member 22 included in the trigger switch 2 of the disclosure. FIG. 7 illustrates the holding member 201 in a state supported by the shaft member 22. The holding member 201 is formed in a substantially rectangular parallelepiped shape having eaves extending toward the rear side at an upper part. The rear surface of the holding member 201 is supported by the shaft member 22. Recesses used as the locking parts 201a are formed on the left and right lateral surfaces of the shaft member 22. The recess used as the locking part 201a is formed such that a surface that engages with the trigger cap 200 forms a substantially right angle with respect to the lateral surface of the holding member 201. Further, in the lateral surface of the holding member 201, the lower surface is formed in a tapered shape intersecting obliquely with the lateral surface of the holding member 201. Regulating pieces 201b (regulating parts) that regulate the directions of attachment and removal of the trigger cap 200 are formed at three spots respectively on the left and right lateral surfaces of the holding member 201. The regulating pieces 201b are formed such that two pieces on the front side and one piece on the rear side alternate with each other. The upper regulating piece 201b on the front side is continuous with the eaves of the upper part. The spacing between the front and rear regulating pieces 201b is slightly wider than the width of the locking piece 200c of the trigger cap 200. In the case where the operator performs attachment or removal of the trigger cap 200 to and from the holding member 201, the locking pieces 200c of the trigger cap 200 are regulated to pass between the front and rear regulating pieces 201b.

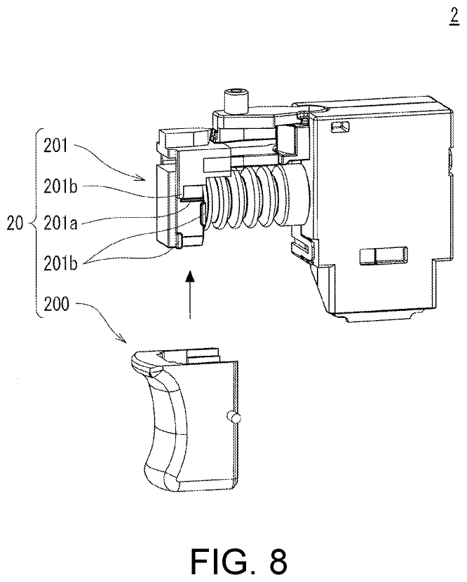

Next, the attachment and removal of the trigger cap 200 will be described. FIG. 8 is a view illustrating an example of an attachment method of the trigger cap 200 in the trigger switch 2 of the disclosure. As illustrated in FIG. 8, in the case of attaching the trigger cap 200 to the holding member 201 of the trigger switch 2, the trigger cap 200 is attached by being pushed in from the lower side toward the upper side in a direction perpendicular (intersecting) to the push-in direction (operation direction) of the trigger 20. Since the attachment direction in the trigger switch 2 is perpendicular to the push-in direction of the trigger 20, during the attachment work, it is difficult for a force to act in the push-in direction of the trigger 20. In the trigger switch 2, a lower surface of the holding member 201 is formed in a tapered shape, and an upper surface of the locking claw 200d of the trigger cap 200 is formed into a tapered shape. Thus, in the trigger switch 2, in the case of attaching the trigger cap 200, the respective tapered surfaces abut against each other, and the spacing between the locking pieces 200c increases while the upper surfaces of the locking pieces 200c slide along the lower surfaces of the locking parts 201a, so the attachment becomes easy. Further, in the trigger switch 2, in a state in which the trigger 20 has been completely attached to the holding member 201, the spacing between the locking pieces 200c returns to the original state, and the surface of the engaging holding member 201 and the lower surfaces of the locking claws 200d engage with each other to prevent the trigger cap 200 from coming off.

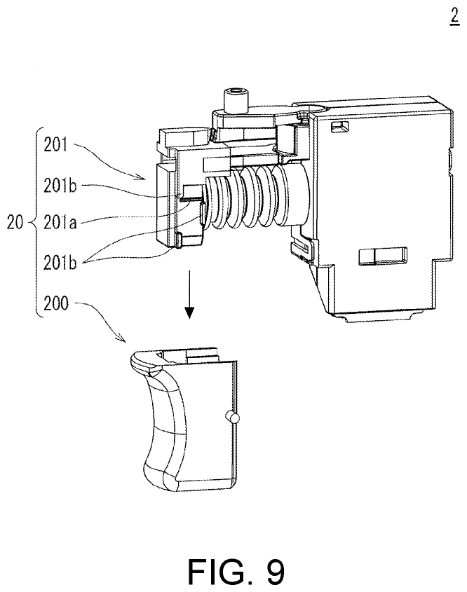

FIG. 9 is a view illustrating an example of a removal method of the trigger cap 200 in the trigger switch 2 of the disclosure. As illustrated in FIG. 9, in the case of removing the trigger cap 200 from the holding member 201 of the trigger switch 2, the trigger cap 200 is removed by being pulled toward the lower side in a direction intersecting with the push-in direction (operation direction) of the trigger 20. In the trigger switch 2, in the case of removing the trigger 20, by pushing the left and right laterals surfaces of the trigger cap 200 with fingers, the locking pieces 200c of the trigger cap 200 bend to widen the spacing between the locking claws 200d, and engagement between the locking parts 201a of the holding member 201 and the locking claws 200d is released, so the removal becomes easy. Further, in the electric device PT of the disclosure, since the moving direction of the trigger 20 and the direction of removing the trigger cap 200 are different from each other, the trigger cap 200 does not come off due to the operation of the trigger 20.

### <Attachment/Removal Work>

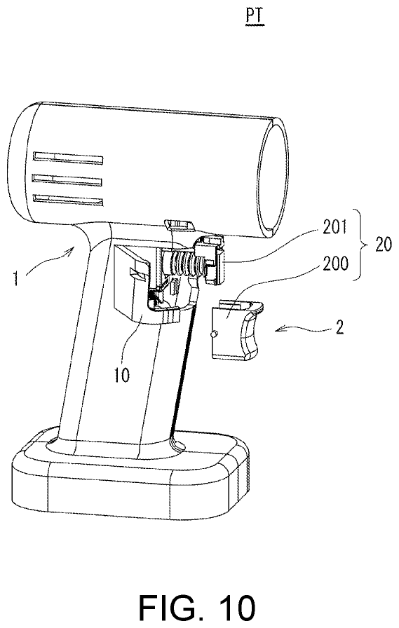

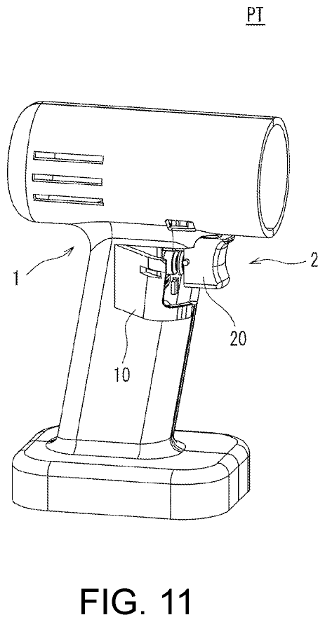

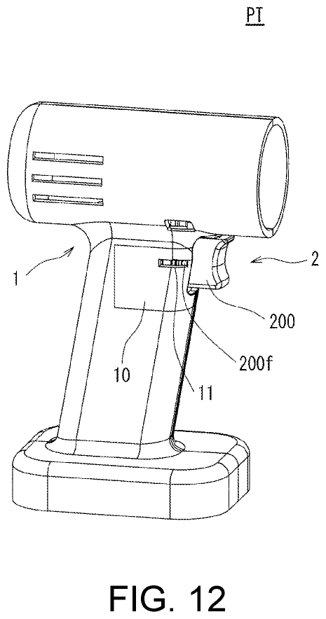

Next, the attachment/removal work of the trigger cap 200 will be described. FIG. 10, FIG. 11, and FIG. 12 are views illustrating an example of a work associated with attachment of the trigger cap 200 in the electric device PT of the disclosure. In FIG. 10, FIG. 11, and FIG. 12, illustration of a tip portion (driver portion of an electric driver) of the electric device PT is omitted. In the electric device PT of the disclosure, when attaching the trigger cap 200 to the trigger switch 2, the work is performed with the door part 10 on the lateral surface opened. The door part 10 is formed to open and close the periphery of an attachment site of the trigger cap 200. In the electric device PT of the disclosure, since the opening of the periphery of the attachment site of the trigger cap 200 can be enlarged due to the door part 10, excellent effects are achieved, such as ease of the attachment/removal work of the trigger cap 200.

FIG. 10 illustrates a state of attaching the trigger cap 200 to the electric device PT with the door part 10 opened. FIG. 11 illustrates a state in which the trigger cap 200 has been attached to the holding member 201 of the trigger switch 2 incorporated into the electric device PT with the door part 10 opened.

FIG. 12 illustrates a state in which attachment of the trigger cap 200 is completed and the door part 10 of the body device 1 is closed. As illustrated in FIG. 12, in the state in which the door part 10 is closed, the regulating protrusion 200f on the lateral surface of the trigger switch 2 becomes protruding from the window part 11 opened on the lateral surface of the body device 1. The operator is capable of visually checking the attachment state of the trigger cap 200 based on the state of the regulating protrusion 200f protruding from the window part 11, and recognizing that the trigger cap 200 has been properly attached to the trigger switch 2. Further, in the case where the operator performs a push-in operation on the trigger switch 2, the movement of the trigger 20 can be checked as the movement of the regulating protrusion 200f. Further, the movement of the trigger 20 is also regulated by the regulating protrusion 200f moving in the front-rear direction within the window part 11.

### <Replacement Example>

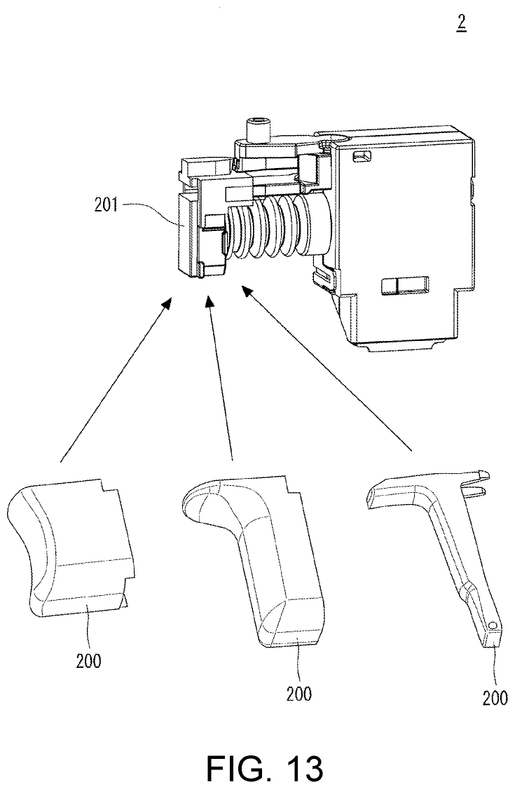

Next, replacement of the trigger cap 200 in the electric device PT of the disclosure will be described. FIG. 13 is a conceptual view illustrating an example of replacement of the trigger cap 200 of the trigger switch 2 of the disclosure. In the trigger switch 2 included in the electric device PT of the disclosure, the trigger cap 200 is attachable and removable. Thus, as conceptually illustrated in FIG. 13, even after the trigger switch 2 of the disclosure is incorporated into the electric device PT, the operator may replace the trigger cap 200 with any trigger cap 200.

As described above, in the trigger switch 2 of the disclosure, the trigger 20 includes the trigger cap 200 having the finger hooking part 200a, and the holding member 201 holding the trigger cap 200. The trigger cap 200 is attachable and removable to and from the holding member 201. Thus, the trigger switch 2 of the disclosure achieves excellent effects, such as being capable of replacing the trigger cap 200 according to various situations including use, maintenance, and the operator's preference.

Further, in the trigger switch 2 of the disclosure, the work of attachment or removal is

performed in a direction intersecting with the push-in direction (longitudinal direction of the shaft member 22) of the trigger 20. Accordingly, the trigger switch 2 of the disclosure achieves excellent effects, such as preventing the trigger 20 from being pushed in the push-in direction during the work. Moreover, the electric device PT of the disclosure achieves excellent effects, such as preventing the trigger cap 200 from coming off in the case of operating the trigger 20.

Further, the trigger switch 2 of the disclosure achieves excellent effects, such as ease of the attachment and removal works of the trigger cap 200 due to the snap-fit structure.

Further, the electric device PT of the disclosure achieves excellent effects, such as allowing visual checking of the attachment state of the trigger cap 200 from the visual check part.

### Second Embodiment

The second embodiment is a form in which the trigger cap 200 attached to the holding member 201 is fixed such that it does not come off in the first embodiment. In the following description, the same configurations as in the first embodiment will be labeled with the same reference signs as in the first embodiment, and referring to descriptions of the first embodiment, detailed descriptions thereof will be omitted.

In the second embodiment, since the configuration of the electric device PT is substantially the same as in the first embodiment, referring to the first embodiment, detailed descriptions thereof will be omitted.

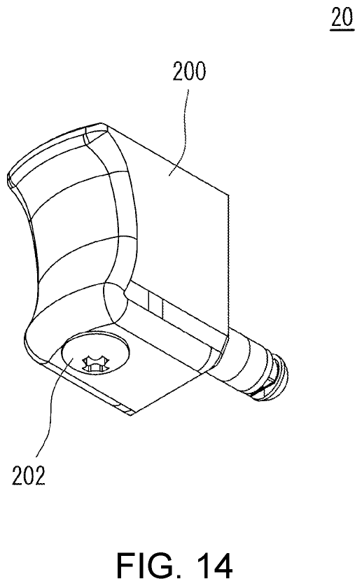

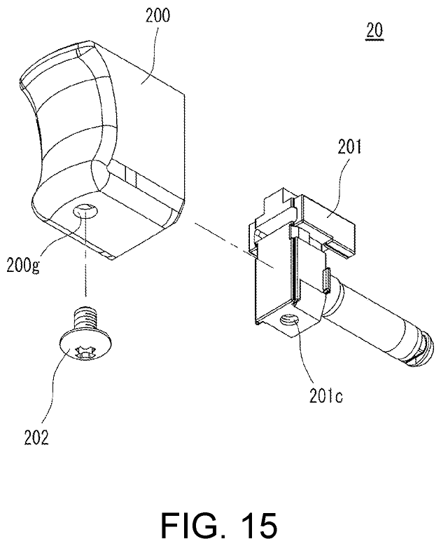

FIG. 14 is a schematic perspective view illustrating an example of a trigger 20 included in a trigger switch 2 of the disclosure. FIG. 15 is a schematic exploded perspective view illustrating an example of the trigger 20 included in the trigger switch 2 of the disclosure. The trigger 20 of the trigger switch 2 according to the second embodiment includes a trigger cap 200 and a holding member 201, and further includes a locking pin 202 as a member that fixes the trigger cap 200 attached to the holding member 201. The locking pin 202 is a pin screw with a male screw structure on which a screw thread is formed.

A through hole 200g is provided through the trigger cap 200, the through hole 200g penetrating from an outer side to an inner side where the holding member 201 is located. The through hole 200g penetrates in the up-down direction from the lower surface of the trigger cap 200 toward the upper side. At the holding member 201, an insertion hole 201c into which a tip of the locking pin 202 can be inserted is formed at a position of a lower part facing the through hole 200g. The insertion hole 201c is formed with a screw thread on the inner side and forms a female screw structure that screws with the locking pin 202.

When attaching the trigger cap 200 to the holding member 201, the locking pin 202 penetrates through the through hole 200g from the outer side of the trigger cap 200 and, with its tip inserted into the insertion hole 201c, the locking pin 202 is screwed into the insertion hole 201c, so the trigger cap 200 can be fixed to the holding member 201.

As described above, the trigger switch 2 of the disclosure achieves excellent effects, such as preventing fall-off of the trigger cap 200 by screwing the trigger cap 200 attached to the holding member 201 with the locking pin 202 using a pin screw. The female screw structure that screws with the locking pin 202 may be configured in various forms, such as forming in the through hole 200g instead of forming in the insertion hole 201c, or further forming in both of the insertion hole 201c and the through hole.

### Third Embodiment

The third embodiment is a form in which the trigger cap 200 attached to the holding member 201 is fixed such that it does not come off, by a structure different from the second embodiment. In the following description, the same configurations as in the embodiments described above will be labeled with the same reference signs as in the embodiments described above, and referring to the embodiments described above, detailed descriptions thereof will be omitted.

In the third embodiment, since the configuration of the electric device PT is substantially the same as in the first embodiment, referring to the first embodiment, detailed descriptions thereof will be omitted.

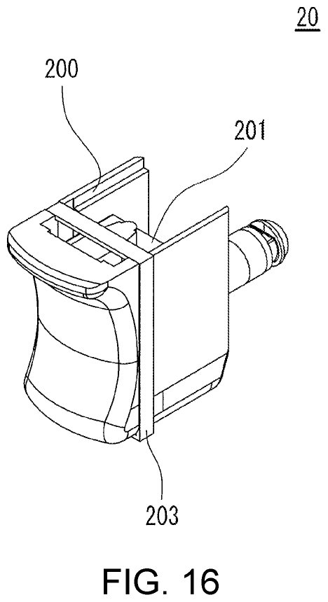

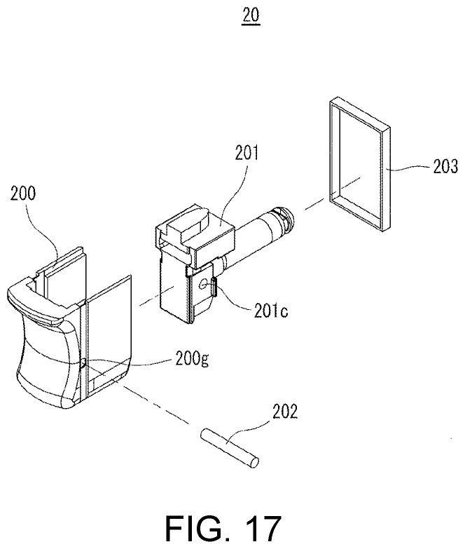

FIG. 16 is a schematic perspective view illustrating an example of a trigger 20 of the disclosure. FIG. 17 is a schematic exploded perspective view illustrating an example of the trigger 20 of the disclosure. In addition to the trigger cap 200, the holding member 201, and the locking pin 202, the trigger 20 of the trigger switch 2 according to the third embodiment further includes a detachment preventing member 203 that prevents detachment of the inserted locking pin 202. The locking pin 202 of the trigger switch 2 according to the third embodiment may not be formed with a screw thread.

A through hole 200g is provided through the trigger cap 200 at a lateral surface, the through hole 200g penetrating from an outer side to an inner side where the holding member 201 is located. At the holding member 201, an insertion hole 201c into which the tip of the locking pin 202 can be inserted is formed at a position on a lateral part facing the through hole 200g .

With the trigger cap 200 attached to the holding member 201, the locking pin 202 is capable of fixing the trigger cap 200 to the holding member 201 by penetrating through the through hole 200g from the outer side of the trigger cap 200 and inserting its tip into the insertion hole 201c .

The detachment preventing member 203 illustrated in FIG. 16 and FIG. 17 is an elastic body such as rubber and is formed in a substantially rectangular frame shape. The detachment preventing member 203 is attached to the trigger cap such that it presses against the locking pin 202 inserted into the through hole 200g and surrounds the trigger cap 200 in the longitudinal direction. A groove is cut along an attachment position of the detachment preventing member 203 at the trigger cap 200, and by fitting the detachment preventing member 203 into the groove, positioning and prevention of displacement during attachment of the detachment preventing member 203 can be achieved. The detachment preventing member 203 attached to the trigger cap 200 prevents detachment of the locking pin 202 by pressing the locking pin 202 in the insertion direction.

With the trigger cap 200 attached to the holding member 201, the locking pin 202 is capable of penetrating the through hole 200g from the outer side of the trigger cap 200 and inserting its tip into the insertion hole 201c to fix the trigger cap 200 to the holding member 201. Furthermore, by attaching the detachment preventing member 203, detachment of the locking pin 202 can be prevented.

As described above, the trigger switch 2 of the disclosure fixes the trigger cap 200 attached to the holding member 201 with the locking pin 202, and further prevents detachment of the locking pin 202 with the detachment preventing member 203. Accordingly, the trigger switch 2 of the disclosure achieves excellent effects, such as preventing fall-off of the trigger cap 200. As long as the detachment preventing member 203 serves the function of preventing detachment of the locking pin 202, the detachment preventing member 203 may be configured in various forms, for example, being composed using a member such as a split pin.

### Fourth Embodiment

The fourth embodiment is a form in which the trigger cap 200 attached to the holding member 201 is fixed such that it does not come off, by a structure different from the second embodiment and the third embodiment. In the following description, the same configurations as in the embodiments described above will be labeled with the same reference signs as in the embodiments described above, and referring to the embodiments described above, detailed descriptions thereof will be omitted.

In the fourth embodiment, since the configuration of the electric device PT is substantially the same as in the first embodiment, referring to the first embodiment, detailed descriptions thereof will be omitted.

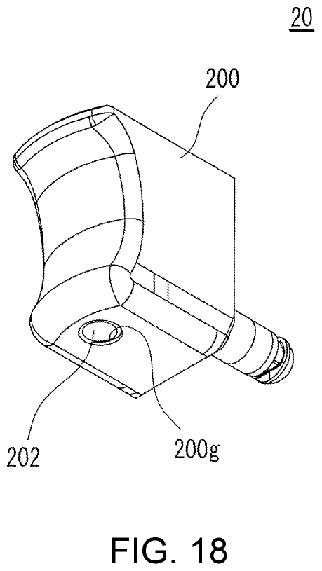

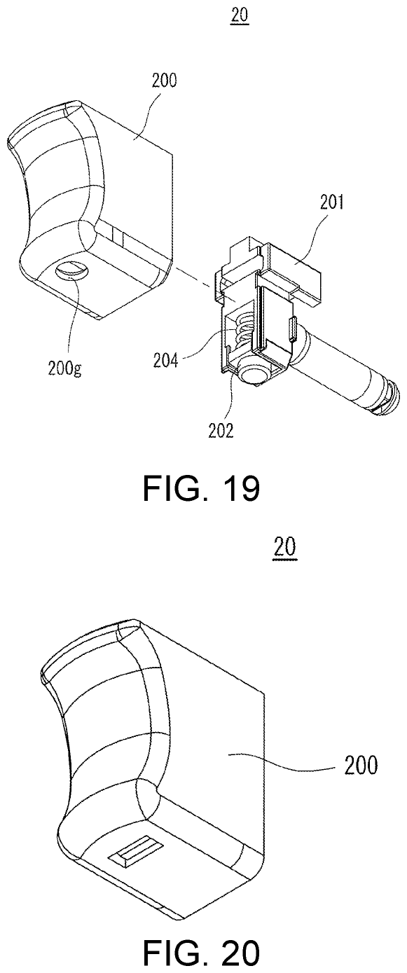

FIG. 18 and FIG. 19 are schematic perspective views illustrating a trigger 20 included in a trigger switch 2 of the disclosure. FIG. 19 is a schematic perspective view of a state in which the trigger cap 200 is removed. In addition to the trigger cap 200, the holding member 201, and the locking pin 202, the trigger 20 of the trigger switch 2 according to the fourth embodiment further includes a biasing member 204 such as a compression coil spring that biases the locking pin 202 in a manner that the locking pin 202 does not come off.

A through hole 200g is provided through the trigger cap 200 at a lower surface, the through hole 200g penetrating from an outer side to an inner side where the holding member 201 is located. The locking pin 202 and the biasing member 204 are attached inside the holding member 201, and a lower surface of the holding member 201 facing the through hole 200g is opened.

The locking pin 202 is attached in the holding member 201 movably in the up-down direction. By moving downward, the lower end of the locking pin 202 inserts into the through hole 200g of the trigger cap 200. In the case where the locking pin 202 is located at a lower limit position within its movement range, its lower end is located in the vicinity of the lower surface of the trigger cap 200. Thus, in the case where the locking pin 202 is located at the lower limit position within its movement range, the operator is capable of pressing the locking pin 202 to push the locking pin 202 inward. Further, by moving upward, the lower end of the locking pin 202 comes off from the through hole 200g. The biasing member 204 is arranged above the locking pin 202 and biases the locking pin 202 downward.

In the case where the trigger cap 200 is attached to the holding member 201, with the locking pin 202 biased by the biasing member 204 to move downward and insert into the through hole 200g, the locking pin 202 is capable of fixing the trigger cap 200 to the holding member 201. Since the locking pin 202 is biased by the biasing member 204, it is difficult to come off from the through hole 200g. Further, in the case where the operator presses the locking pin 202 inserted into the through hole 200g to push the locking pin 202 inward, the locking pin 202 comes off from the through hole 200g and moves upward. As the locking pin 202 inserted into the through hole 200g comes off from the through hole 200g with pressing of the operator from outside of the trigger cap 200, fixing of the trigger cap 200 to the holding member 201 is released.

As described above, since the trigger switch 2 of the disclosure fixes the trigger cap 200 attached to the holding member 201 with the locking pin 202 biased from inside, excellent effects are achieved, such as preventing fall-off of the trigger cap 200. As long as the locking pin 202 can be pressed inward, the through hole 200g may be configured in various forms, such as not necessarily being a through hole.

### Fifth Embodiment

The fifth embodiment is a form in which the trigger cap 200 attached to the holding member 201 is fixed such that it does not come off, by a structure different from the second embodiment to the fourth embodiment. In the following description, the same configurations as in the embodiments described above will be labeled with the same reference signs as in the embodiments described above, and referring to the embodiments described above, detailed descriptions thereof will be omitted.

In the fifth embodiment, since the configuration of the electric device PT is substantially the same as in the first embodiment, referring to the first embodiment, detailed descriptions thereof will be omitted.

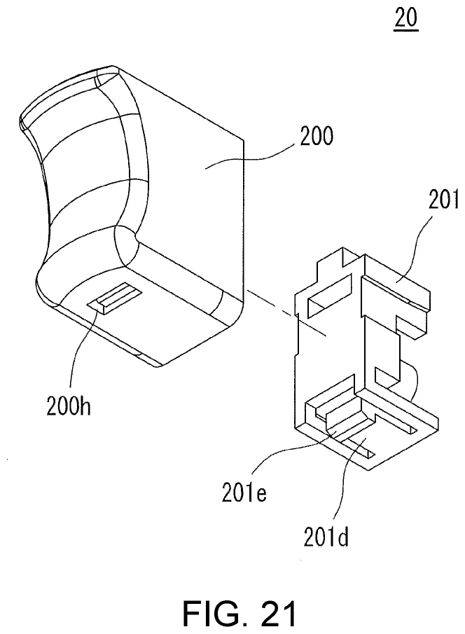

FIG. 20 and FIG. 21 are schematic perspective views illustrating a trigger 20 included in a trigger switch 2 of the disclosure. FIG. 21 is a schematic perspective view of a state in which the trigger cap 200 is removed. The trigger 20 of the trigger switch 2 according to the fifth embodiment includes a trigger cap 200 and a holding member 201.

A through locking part 200h (locking part) is provided through the trigger cap 200 at a lower surface, the through locking part 200h penetrating from an outer side to an inner side where the holding member 201 is located. The holding member 201 is formed with a biasing locking piece 201d (locking piece) at a lower part, the biasing locking piece 201d being formed with a biasing locking claw 201e (locking claw) at its tip. The biasing locking piece 201d has a snap-fit structure biasing downward.

In the case where the trigger cap 200 is attached to the holding member 201, by fitting the biasing locking claw 201e of the biasing locking piece 201d into the through locking part 200h, the trigger cap 200 can be fixed to the holding member 201. Further, since the through locking part 200h penetrates from the outer side to the inner side, the operator is capable of pressing the biasing locking claw 201e fitted into the through locking part 200h to push the biasing locking claw 201e inward. With the operator performing a press operation to release engagement of the biasing locking claw 201e, fixing of the trigger cap 200 to the holding member 201 is released.

As described above, since the trigger switch 2 of the disclosure fixes the trigger cap 200 attached to the holding member 201 by a snap-fit structure different from the first embodiment, excellent effects are achieved, such as preventing fall-off of the trigger cap 200.

### Sixth Embodiment

The sixth embodiment is a form different from the first embodiment and is a form in which the size of the opening in the periphery of the attachment site of the trigger cap 200 is adjusted. In the following description, the same configurations as in the first embodiment will be labeled with the same reference signs as in the first embodiment, and referring to descriptions of the first embodiment, detailed descriptions thereof will be omitted.

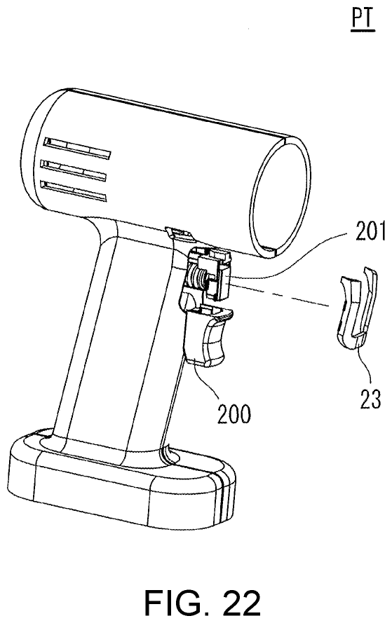

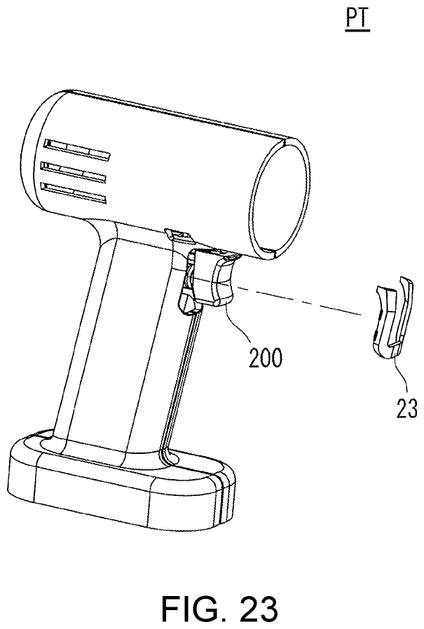

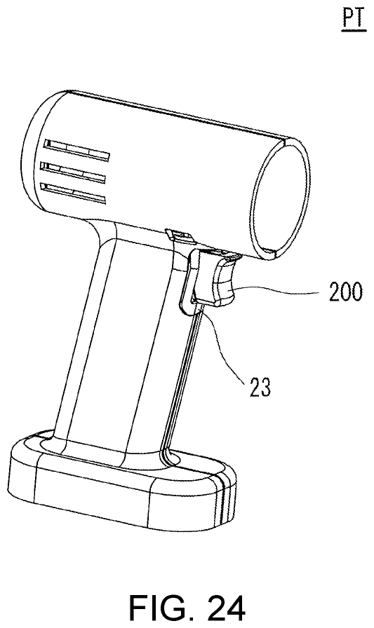

FIG. 22, FIG. 23, and FIG. 24 are views illustrating an example of a work associated with attachment of a trigger cap 200 in an electric device PT of the disclosure. In FIG. 22, FIG. 23, and FIG. 24, illustration of the tip portion of the electric device PT is omitted. The electric device PT of the disclosure includes an adjustment member 23 that adjusts the size of the opening in the periphery of the attachment site of the trigger cap 200. The adjustment member 23 is formed in a substantially U-shape along the shape of an edge part of the opening.

FIG. 22 illustrates a state in which the trigger cap 200 is to be attached to the electric device PT from which the adjustment member 23 is removed. FIG. 23 illustrates a state in which the trigger cap 200 is attached to the holding member 201 of the trigger switch 2 incorporated into the electric device PT from which the adjustment member 23 is removed. FIG. 24 illustrates a state in which attachment of the trigger cap 200 is completed and the adjustment member 23 is attached to the electric device PT. Since the electric device PT of the disclosure is capable of enlarging the opening in the periphery of the attachment site of the trigger cap 200 by removing the adjustment member 23, excellent effects are achieved, such as ease of the attachment/removal work of the trigger cap 200.

The disclosure is not limited to the embodiments described above and may be implemented in various other forms. Thus, the embodiments described above are merely illustrative in all respects and should not be interpreted restrictively. The technical scope of the disclosure is defined by the scope of the claims and is not bound by the description of the specification. Furthermore, all modifications and changes belonging to equivalent scopes of the claims fall within the scope of the disclosure.

For example, in the above embodiments, it has been illustrated that the trigger cap 200 is capable of being attached and removed by a snap-fit structure, but the trigger switch 2 of the disclosure may be applied to various structures without being limited thereto. For example, the trigger switch 2 of the disclosure may be configured in various forms, such as enabling attachment and removal of the trigger cap 200 and the holding member 201 constituting the trigger 20 by various methods such as pins, screws, fitting, magnets, etc.

Further, for example, in the above embodiments, it has been illustrated that the trigger cap 200 is attached from below the holding member 201, but the trigger cap 200 may be configured in various forms, for example, being attached from a direction intersecting with the push-in direction such as the lateral side and the upper side, or further, from a direction parallel to the push-in direction.

In other words, the trigger switch 2 and the electric device PT of the disclosure may be configured in various forms related to the following supplementary notes.

### (Supplementary Note 1)

A trigger switch including: a trigger that receives a push-in operation of an operator; and a shaft member that supports the trigger, wherein the trigger moves in an operation direction in which the trigger is pushed in by the push-in operation,

the trigger includes:

a trigger cap including a finger hooking part onto which a finger of the operator is hooked; and

a holding member that holds the trigger cap and is supported by the shaft member, and

the trigger cap is attachable and removable to and from the holding member.

### (Supplementary Note 2)

The trigger switch according to Supplementary note 1, wherein

the holding member is formed with a regulating part that performs regulation such that a direction of attachment or removal of the trigger cap is a predetermined intersection direction intersecting with the operation direction.

### (Supplementary Note 3)

The trigger switch according to Supplementary note 1 or 2, wherein attachment of the trigger cap to the holding member is performed with a snap-fit structure in which a locking claw engages with a locking part.

### (Supplementary Note 4)

The trigger switch according to Supplementary note 3, wherein

the trigger cap is attached by fitting over the holding member,

the holding member is formed with the locking part,

the trigger cap includes:

a wall body that covers the locking part upon fitting over; and

a locking piece formed with the locking claw at a tip,

the locking piece is formed at a position separated from an inner surface of the wall body on an inner side of the wall body, and

a site of the wall body that is opposed to the locking claw is formed into a recessed shape.

### (Supplementary Note 5)

The trigger switch according to Supplementary note 3, wherein

the trigger cap is formed with the locking part, and

the holding member is a locking piece formed with the locking claw at a tip.

### (Supplementary Note 6)

The trigger switch according to any one of Supplementary notes 1 to 5, wherein

the trigger cap is formed with a through hole,

the trigger switch further includes a locking pin capable of being inserted into the through hole, and

by inserting the locking pin into the through hole of the trigger cap attached to the holding member, the locking pin locks the trigger cap, and the trigger cap is fixed.

### (Supplementary Note 7)

The trigger switch according to Supplementary note 6, wherein

the through hole penetrates from an outer side of the trigger cap to an inner side where the holding member is located,

the holding member is formed with an insertion hole at a position facing the through hole, a tip of the locking pin being capable of being inserted into the insertion hole,

the locking pin is a pin screw forming a male screw structure, and is capable of fixing the trigger cap to the holding member by penetrating from the outer side of the trigger cap through the through hole and inserting the tip into the insertion hole, and

the through hole or the insertion hole forms a female screw structure that screws with the locking pin.

### (Supplementary Note 8)

The trigger switch according to Supplementary note 6, wherein

the through hole penetrates from an outer side of the trigger cap to an inner side where the holding member is located,

the holding member is formed with an insertion hole at a position facing the through hole, a tip of the locking pin being capable of being inserted into the insertion hole,

the locking pin is capable of fixing the trigger cap to the holding member by penetrating from the outer side of the trigger cap through the through hole and inserting the tip into the insertion hole, and

the trigger switch includes a detachment preventing member that prevents detachment of the locking pin inserted into the through hole.

### (Supplementary Note 9)

The trigger switch according to Supplementary note 6, wherein

the through hole penetrates from an outer side of the trigger cap to an inner side where the holding member is located,

the locking pin is movably attached to the holding member,

the locking pin is capable of fixing the trigger cap to the holding member by inserting from the inner side of the trigger cap into the through hole, and

with the locking pin inserted into the through hole coming off from the through hole with pressing from outside of the trigger cap, fixing of the trigger cap to the holding member is released.

### (Supplementary Note 10)

An electric device including:

the trigger switch according to any one of Supplementary notes 1 to 9; and

a body device that is driven in response to a push-in operation on the trigger switch, wherein

the body device includes a visual check part that allows visual checking of an attachment state of the trigger cap in the trigger switch.

### (Supplementary Note 11)

An electric device including:

the trigger switch according to any one of Supplementary notes 1 to 9; and

a body device that is driven in response to a push-in operation on the trigger switch, wherein

the body device is formed with an opening in a periphery of an attachment site of the trigger cap, and includes an adjustment member that adjusts a size of the opening.

### (Supplementary Note 12)

An electric device including:

the trigger switch according to any one of Supplementary notes 1 to 9; and

a body device that is driven in response to a push-in operation on the trigger switch, wherein

the body device includes a door part that opens and closes a periphery of an attachment site of the trigger cap.

What is claimed is:

1. A trigger switch comprising: a trigger that receives a push-in operation of an operator; and a shaft member that supports the trigger, wherein the trigger moves in an operation direction in which the trigger is pushed in by the push-in operation,
the trigger comprises:
a trigger cap comprising a finger hooking part onto which a finger of the operator is hooked; and
a holding member that holds the trigger cap and is supported by the shaft member, and
the trigger cap is attachable and removable to and from the holding member.

2. The trigger switch according to claim 1, wherein
the holding member is formed with a regulating part that performs regulation such that a direction of attachment or removal of the trigger cap is a predetermined intersection direction intersecting with the operation direction.

3. The trigger switch according to claim 1, wherein
attachment of the trigger cap to the holding member is performed with a snap-fit structure in which a locking claw engages with a locking part.

4. The trigger switch according to claim 3, wherein
the trigger cap is attached by fitting over the holding member,
the holding member is formed with the locking part,
the trigger cap comprises:
a wall body that covers the locking part upon fitting over; and
a locking piece formed with the locking claw at a tip,
the locking piece is formed at a position separated from an inner surface of the wall body on an inner side of the wall body, and
a site of the wall body that is opposed to the locking claw is formed into a recessed shape.

5. The trigger switch according to claim 3, wherein
the trigger cap is formed with the locking part, and
the holding member is a locking piece formed with the locking claw at a tip.

6. The trigger switch according to claim 2, wherein
attachment of the trigger cap to the holding member is performed with a snap-fit structure in which a locking claw engages with a locking part.

7. The trigger switch according to claim 6, wherein
the trigger cap is attached by fitting over the holding member,
the holding member is formed with the locking part,
the trigger cap comprises:
a wall body that covers the locking part upon fitting over; and
a locking piece formed with the locking claw at a tip,
the locking piece is formed at a position separated from an inner surface of the wall body on an inner side of the wall body, and
a site of the wall body that is opposed to the locking claw is formed into a recessed shape.

8. The trigger switch according to claim 6, wherein
the trigger cap is formed with the locking part, and
the holding member is a locking piece formed with the locking claw at a tip.

9. The trigger switch according to claim 1, wherein
the trigger cap is formed with a through hole,
the trigger switch further comprises a locking pin capable of being inserted into the through hole, and
by inserting the locking pin into the through hole of the trigger cap attached to the holding member, the locking pin locks the trigger cap, and the trigger cap is fixed.

10. The trigger switch according to claim 9, wherein
the through hole penetrates from an outer side of the trigger cap to an inner side where the holding member is located,
the holding member is formed with an insertion hole at a position facing the through hole, a tip of the locking pin being capable of being inserted into the insertion hole,
the locking pin is a pin screw forming a male screw structure, and is capable of fixing the trigger cap to the holding member by penetrating from the outer side of the trigger cap through the through hole and inserting the tip into the insertion hole, and
the through hole or the insertion hole forms a female screw structure that screws with the locking pin.

11. The trigger switch according to claim 9, wherein
the through hole penetrates from an outer side of the trigger cap to an inner side where the holding member is located,
the holding member is formed with an insertion hole at a position facing the through hole, a tip of the locking pin being capable of being inserted into the insertion hole,
the locking pin is capable of fixing the trigger cap to the holding member by penetrating from the outer side of the trigger cap through the through hole and inserting the tip into the insertion hole, and
the trigger switch comprises a detachment preventing member that prevents detachment of the locking pin inserted into the through hole.

12. The trigger switch according to claim 9, wherein
the through hole penetrates from an outer side of the trigger cap to an inner side where the holding member is located,
the locking pin is movably attached to the holding member,
the locking pin is capable of fixing the trigger cap to the holding member by inserting from the inner side of the trigger cap into the through hole, and
with the locking pin inserted into the through hole coming off from the through hole with pressing from outside of the trigger cap, fixing of the trigger cap to the holding member is released.

13. The trigger switch according to claim 2, wherein
the trigger cap is formed with a through hole,
the trigger switch further comprises a locking pin capable of being inserted into the through hole, and
by inserting the locking pin into the through hole of the trigger cap attached to the holding member, the locking pin locks the trigger cap, and the trigger cap is fixed.

14. The trigger switch according to claim 13, wherein
the through hole penetrates from an outer side of the trigger cap to an inner side where the holding member is located,
the holding member is formed with an insertion hole at a position facing the through hole, a tip of the locking pin being capable of being inserted into the insertion hole,
the locking pin is a pin screw forming a male screw structure, and is capable of fixing the trigger cap to the holding member by penetrating from the outer side of the trigger cap through the through hole and inserting the tip into the insertion hole, and
the through hole or the insertion hole forms a female screw structure that screws with the locking pin.

15. The trigger switch according to claim 13, wherein
the through hole penetrates from an outer side of the trigger cap to an inner side where the holding member is located,
the holding member is formed with an insertion hole at a position facing the through hole, a tip of the locking pin being capable of being inserted into the insertion hole,
the locking pin is capable of fixing the trigger cap to the holding member by penetrating from the outer side of the trigger cap through the through hole and inserting the tip into the insertion hole, and
the trigger switch comprises a detachment preventing member that prevents detachment of the locking pin inserted into the through hole.

16. The trigger switch according to claim 13, wherein
the through hole penetrates from an outer side of the trigger cap to an inner side where the holding member is located,
the locking pin is movably attached to the holding member,
the locking pin is capable of fixing the trigger cap to the holding member by inserting from the inner side of the trigger cap into the through hole, and
with the locking pin inserted into the through hole coming off from the through hole with pressing from outside of the trigger cap, fixing of the trigger cap to the holding member is released.

17. An electric device comprising:
the trigger switch according to claim 1; and
a body device that is driven in response to a push-in operation on the trigger switch, wherein
the body device comprises a visual check part that allows visual checking of an attachment state of the trigger cap in the trigger switch.

18. An electric device comprising:
the trigger switch according to claim 2; and
a body device that is driven in response to a push-in operation on the trigger switch, wherein
the body device comprises a visual check part that allows visual checking of an attachment state of the trigger cap in the trigger switch.

19. An electric device comprising:
the trigger switch according to claim 1; and
a body device that is driven in response to a push-in operation on the trigger switch, wherein
the body device is formed with an opening in a periphery of an attachment site of the trigger cap, and comprises an adjustment member that adjusts a size of the opening.

20. An electric device comprising:
the trigger switch according to claim 1; and
a body device that is driven in response to a push-in operation on the trigger switch, wherein
the body device comprises a door part that opens and closes a periphery of an attachment site of the trigger cap.
